(19) United States
(12) Patent Application Publication
(10) Pub. No.: US 2016/0299667 A1
(43) Pub. Date: Oct. 13, 2016

(54) IMAGE MANIPULATION SYSTEM

(71) Applicant: Robert Joe Alexander, Folsom, CA (US)

(72) Inventor: Robert Joe Alexander, Folsom, CA (US)

(21) Appl. No.: 15/095,014

(22) Filed: Apr. 9, 2016

Related U.S. Application Data
(60) Provisional application No. 62/146,364, filed on Apr. 12, 2015.

(51) Int. Cl. G06F 3/0484; G06F 3/0482

(52) U.S. Cl. CPC G06F 3/04845; G06F 3/0482; G06F 2203/04805

(57) ABSTRACT

An image manipulation system is disclosed. The image manipulation system includes one or more processors configured to receive an input from a user on an image, wherein the image comprising a first object and a plurality of second objects, wherein the first object is positioned in a first portion of the image and the plurality of second objects are positioned in second portion of the image. The one or more processors are further configured to replace the first object with one of the plurality of second objects based on the input received from the user, wherein state of the first object is different from a state of the plurality of second objects.

### CROSS REFERENCE TO RELATED APPLICATIONS

This application claims the benefit of U.S. Priority Patent Application 62/146,364 filed on Apr. 12, 2015 with title “Image Manipulation for Viewing, Learning & Building”, the entire contents of which are incorporated herein by reference.

### TECHNICAL FIELD OF INVENTION

The present disclosure relates to the field of image processing. More particularly, the present disclosure relates to image manipulation systems.

### BACKGROUND

In today's world, computation power of digital devices has increased exponentially due to which image processing on these devices have significantly improved. In combination with increased computation power, higher memory capacity enables image processing or image manipulation to take place on the mobile communications apparatus itself instead of on a dedicated computer running dedicated image processing tools. Although powerful, dedicated image processing or image manipulation tools may be complex and may possess a high learning curve for a user. It may therefore be desirable for the user to be able to perform advanced image processing or image manipulation directly on the mobile communications apparatuses, i.e. without having to resort to using a dedicated computer or to spend time learning how to use complex tools.

Conventionally, in order to perform image manipulation, users have to use complex functionalities and conventional tools, which create inconvenience to users.

Thus, there is felt a need to alleviate drawbacks associated with conventional image manipulation systems.

### SUMMARY

In one aspect of the present disclosure, an image manipulation system is disclosed. The image manipulation system includes one or more processors configured to receive an input from a user on an image, wherein the image comprising a first object and a plurality of second objects, wherein the first object is positioned in a first portion of the image and the plurality of second objects are positioned in second portion of the image. The one or more processors are further configured to replace the first object with one of the plurality of second objects based on the input received from the user, wherein state of the first object is different from a state of the plurality of second objects.

In another aspect of the present disclosure, an image manipulation method is disclosed. The method includes receiving an input from a user on an image, wherein the image comprising a first object and a plurality of second objects, wherein the first is positioned in a first portion of the image and the plurality of second objects are positioned in second portion of the image. The method further includes replacing the first object with one of the plurality of second objects based on the input received from the user, wherein state of the first object is different from a state of the plurality of second objects.

### BRIEF DESCRIPTION OF THE ACCOMPANYING DRAWINGS

The novel features which are believed to be characteristic of the present disclosure, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this disclosure will now be described by way of example in association with the accompanying drawings in which:

FIG. 1 is a schematic view of an image manipulation system in accordance with an embodiment of the present disclosure;

FIG. 2 illustrates an electronic device utilized by the image manipulation system of FIG. 1, in accordance with an embodiment of the present disclosure; and

FIG. 3 illustrates an exemplary image being utilized by the image manipulation system of the FIG. 1.

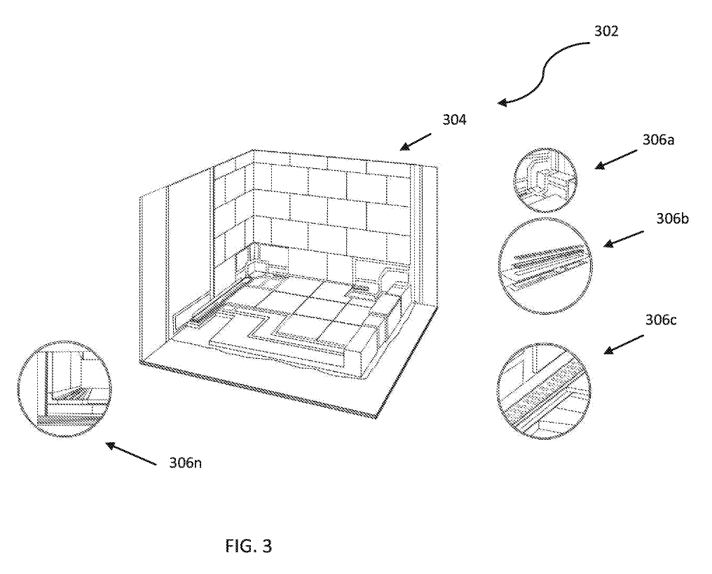

### DETAILED DESCRIPTION

The terminology used in the present disclosure is for the purpose of describing exemplary embodiments and is not intended to be limiting. The terms “comprises,” “comprising,” “including,” and “having,” are inclusive and therefore specify the presence of stated features, operations, elements, and/or components, but do not exclude the presence other features, operations, elements, and/or components thereof. The method steps and processes described in the present disclosure are not to be construed as necessarily requiring their performance in the particular order illustrated, unless specifically identified as an order of performance.

In an event an element is referred to as being “on”, “engaged to”, “connected to” or “coupled to” another element, it may be directly on, engaged, connected or coupled to the other element, or intervening elements may be present. On the contrary, in an event an element is referred to as being “directly on,” “directly engaged to”, “directly connected to” or “directly coupled to” another element, there may be no intervening elements present. Other words used to describe the relationship between elements should be interpreted in a like fashion. Further, the term “and/or” includes any and all combinations of one or more of the associated listed items.

Although the terms first, second, third, etc. may be used herein to describe various elements, components, regions, and/or sections, these elements, components, regions, and/or sections should not be limited by these terms. These terms may be only used to distinguish one element, component, region, or section from another region, layer or section. Terms such as “first,” “second,” and other numerical terms when used herein do not imply a sequence or order unless clearly indicated by the context.

The image manipulation system of the present disclosure will now be described with reference to the accompanying drawings, which does not restrict the scope and ambit of the disclosure. The description provided is purely by way of example and illustration.

The image manipulation system of the present disclosure is hereinafter described with reference to an electronic device which may be a computer, personal digital assistant (PDA), a mobile phone, a tablet, and/or a laptop. The electronic device may be connected to a server to receive image data. However, the electronic may not always be connected to the server and the image data may also be stored locally on the electronic device.

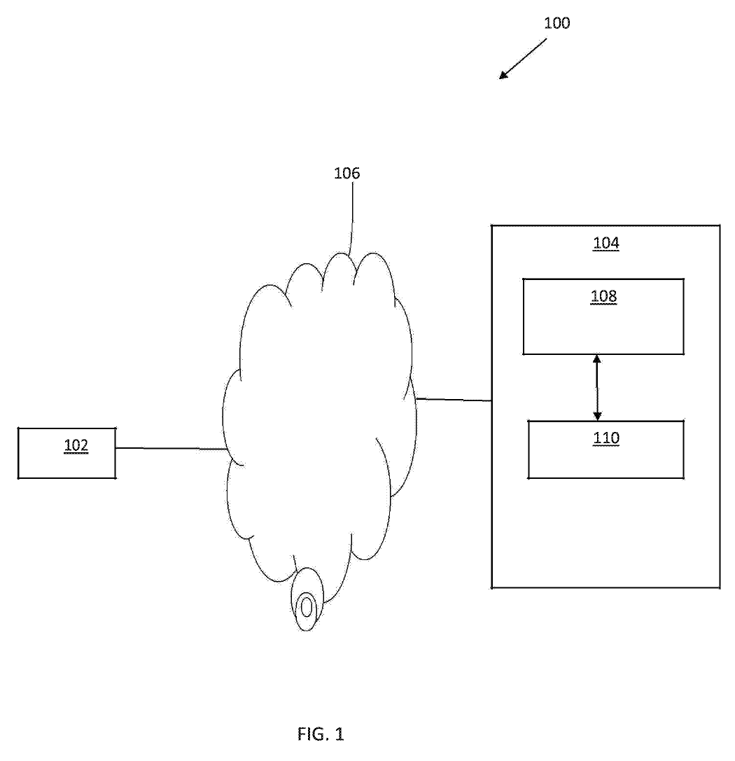

Referring to FIG. 1, the system 100 includes an electronic device 102, a server 104, and a communication network 106. The server 104 includes a central processing unit (CPU) 108 and a data storage 110. The electronic device 102 may be communicably connected to the computer 104 through the communication network 106. In an embodiment, the electronic device 102 may be connected to the server 104 through a wireless network such as Global System for Mobile Communication (GSM), Code Division Multiple Access (CDMA), 2G, 3G, and 4G. In another embodiment, the electronic device 102 may be connected to the server 104 through a wired connection which may include dedicate lines that may be part of a local area network (LAN) or a wide area network (WAN).

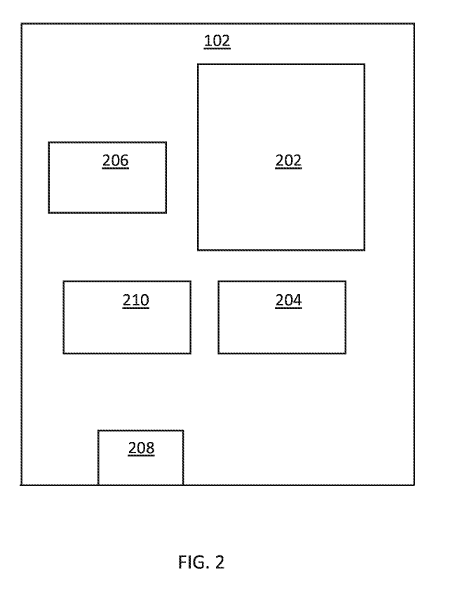

Referring to FIG. 2, an electronic device 102 may include one or more processors, such as a processor 202, one or more memory, such as memory 204, a transceiver 206, one or more I/O interfaces, such as an I/O interface 208 and a display 210.

The processor 202 may be communicably coupled with the transceiver 206 to receive signals from the server 104. Further, the transceiver 206 may be configured to transmit signals generated by the processor 202. The processor 202 is in communication with the memory 204, wherein the memory 204 includes program modules such as routines, programs, objects, components, data structures and the like, which perform particular tasks to be executed by the processor 202. The electronic device 202 may be connected to other electronic devices by using the I/O interface 208. The display 210 may be utilized to receive inputs from a user using the electronic device 102. The I/O interfaces 116 may include a variety of software and hardware interfaces, for instance, interface for peripheral device(s) such as a keyboard, a mouse, a scanner, an external memory, a printer and the like.

The display 210 may be a touch screen configured to sense touch being performed by a user. The display 210 is further adapted to display an image 302 thereon. The image 302 may be one of a pre-stored image of the user or the image 302 may be captured in real time by an imaging device such as a camera. In an embodiment, the image 302 may be received by the electronic device 102 from a server 104 through a wireless or a wired connection.

The user may perform a number of operations on the display 210, wherein the display is adapted to sense all the operations performed by the user and generate a signal corresponding to the sensed operations. The generated signal which corresponds to user inputs is processed by the processor 202 to reflect changes on the image 302 being displayed on the display 210.

The image 302 being displayed on the display 210 includes a first object 304 and a plurality of second objects (306a, 306b, 306c . . . 306n). The first object 304 is displayed in a first portion of the image 302, such as a center position of the image being displayed on the display 210. The second objects (306a, 306b, 306c . . . 306n) may be displayed in a second portion excluding the first portion, such as corners of the image 302 being displayed on the display 210. It would be appreciated from a person ordinary skill in the art that the first portion and the second portion may refer to other portions of the image 302 being displayed based on the desire of a user utilizing the electronic device 102. Further, state of the first object 304 is different than a state of the second objects (306a, 306b, 306c . . . 306n). The state herein may refer to but not limited to size and view of the objects.

In a non-limited exemplary embodiment, the electronic device 102 may be used by the user to learn about building construction. To learn construction, an image 302 of an interior of a building or a skeleton of a building may be displayed on the display 210. The image 302 may include some parts of the building in a magnified view, thereby corresponding to the first object 304 in the first state as discussed above. Further, the image 302 may include some alternatives to the parts of the building being present in the magnified view, thereby the alternatives being present refers to the second objects (306a, 306b, 306c, . . . 306n) as discussed above. The user may alter the first object 304 by using any of the second objects (306a, 306b, 306c, . . . 306n) as per his desire.

In an embodiment, the image 302 being displayed on the display 210 is a two-dimensional image. In another embodiment, the image 302 may be a three-dimensional image.

The invention has mainly been described above with reference to a certain examples. However, as is readily appreciated by a person skilled in the art, other examples than the ones disclosed above are equally possible within the scope of the invention, as defined by the appended patent claims.

1. An image manipulation system, comprising:
one or more processors configured to:
receive an input from a user on an image, wherein said image comprising a first object and a plurality of second objects, wherein said first object is positioned in a first portion of said image and said plurality of second objects are positioned in second portion of said image; and
replace said first object with one of said plurality of second objects based on said input received from said user, wherein state of said first object is different from a state of said plurality of second objects.

2. The image manipulation system according to claim 1, wherein said image is a pre-stored image in a storage system associated with said image manipulation system.

3. The image manipulation system according to claim 1, wherein said image is a real time image captured by an imaging device associated with said image manipulation system.

4. The image manipulation system according to claim 1, wherein said first portion covers a larger area of said image with respect to said second portion.

5. The image manipulation system according to claim 1, wherein said first portion is a central portion of said image and wherein said second portion is a corner portion of said image.

6. The image manipulation system according to claim 1, wherein said input from said user is one of a haptic input, a gesture control input and/or an input through Input/output devices.

7. The image manipulation system according to claim 1, further comprising a display configured to display said image.

8. The image manipulation system according to claim 1, wherein said first state corresponds to a magnified view of said first object, and wherein said second state corresponds to a view smaller than said magnified view of said first object.

9. An image manipulation method, comprising:
in an electronic device:
receiving an input from a user on an image, wherein said image comprising a first object and a plurality of second objects, wherein said first is positioned in a first portion of said image and said plurality of second objects are positioned in second portion of said image; and
replacing said first object with one of said plurality of second objects based on said input received from said user, wherein state of said first object is different from a state of said plurality of second objects.

10. The image manipulation method according to claim 9, further comprising a step of displaying said image on a graphical user interface.
